(19) United States
(12) Patent Application Publication
(10) Pub. No.: US 2010/0035031 A1
(43) Pub. Date: Feb. 11, 2010

(54) OPTICAL LAYERED BODY, METHOD FOR PRODUCING THE SAME, AND COMPOSITION FOR ANTISTATIC LAYER

(75) Inventors: Kiyoshi Itoh, Tokyo (JP); Masataka Nakashima, Tokyo (JP); Tomoyuki Horio, Tokyo (JP)

Correspondence Address: CONNOLLY BOVE LODGE & HUTZ LLP, 1875 EYE STREET, N.W., SUITE 1100, WASHINGTON, DC, 20006, US

(73) Assignee: Dai Nippon Printing Co., Ltd., Tokyo (JP)

(21) Appl. No.: 12/520,478

(22) PCT Filed: Dec. 21, 2007
(86) PCT No.: PCT/JP2007/074702

§ 371 Date: Sep. 9, 2009

(51) Int. Cl. B32B 7/02; B32B 27/00; B05D 5/06; B05D 5/12; G02B 1/10; G02B 1/11; G02F 1/1335

(52) U.S. Cl. 428/204; 427/164; 252/500

(57) ABSTRACT

It is an object of the present invention to provide a method for producing an optical layered body having a favorable self-adhesion property and recoatability as well as favorable antistatic performance in a simple manner.

An optical layered body comprises:
an antistatic layer on a light-transmitting substrate; and a hard coat layer on the antistatic layer,
wherein the hard coat layer includes a penetration portion partially extending through the antistatic layer, and/or an impregnation portion partially extending through the antistatic layer and impregnating the light-transmitting substrate.

### TECHNICAL FIELD

The present invention relates to an optical layered body, a method for producing an optical layered body, and a composition for an antistatic layer.

### BACKGROUND ART

An optical layered body, which includes functional layers having various properties such as an antireflection property, a hardness property, and transparency, is provided on the outermost surface of image display devices such as cathode-ray tube (CRT) display devices, liquid crystal displays (LCD), plasma displays (PDP) and electroluminescence displays (ELD). These functional layers are formed on a substrate of a material having a remarkable hardness and transparency such as acrylic resin. The substrate for these functional layers, however, is likely to be charged due to its high insulating property, and thereby suffer from stain problems such as adhesion of dust. In addition, the substrate may be charged to cause problems in display production processes as well as in use.

In order to avoid electrostatic charge, an antistatic layer containing a conductive antistatic agent is provided in a part of the above-mentioned optical layered body in the conventional art. The above-mentioned antistatic agent has been formed with a known antistatic agent such as quarternary ammonium salt, and an inorganic conductive ultrafine particle.

For obtaining a favorable antistatic agent, use of conductive polymers has been recently attracting attention instead of various antistatic agents because the conductive polymers are favorable conductive materials having permanent conductivity and excellent transparency.

However, these conductive polymers problematically fail to give the antistatic layer sufficient adhesion properties, that is, an adhesion property that allows the antistatic layer to adhere to the substrate (self-adhesion property) and an adhesion property that allows the antistatic layer to adhere to a layer formed thereon such as a hard coat layer (recoatability: property that allows easy coating on a coated layer without repelling). For example, Patent Documents 1 to 3 disclose methods using conductive polymers, which solve problems on the self-adhesion property and recoatability.

These methods, however, require another layer such as an adhesive layer interposed between them, that is, require additional processes, which in turn leads to an increase in cost.

Patent Document 1: JP-A 2003-131008

Patent Document 2: JP-A 2005-231089

Patent Document 3: JP-A 2005-238651

### DISCLOSURE OF THE INVENTION

### Problems to be Solved by the Invention

In view of the above-mentioned problems, the present invention aims to provide an optical layered body in which a favorable self-adhesion property and recoatability as well as a favorable antistatic property are achieved in a simple manner, and a method for producing an optical layered body.

### Means for Solving the Problems

The present invention provides an optical layered body, comprising: an antistatic layer on a light-transmitting substrate; and a hard coat layer on the antistatic layer, wherein the hard coat layer includes a penetration portion partially extending through the antistatic layer, and/or an impregnation portion partially extending through the antistatic layer and impregnating the light-transmitting substrate.

The above-mentioned light-transmitting substrate is preferably made of triacetylcellulose.

Preferably, the above-mentioned antistatic layer is formed from a composition for an antistatic layer comprising a resin particle, and the resin particle has a particle size so that a part of the resin particle corresponding to 5 to 50% of the particle size of the resin particle projects from the surface of the antistatic layer.

Preferably, the above-mentioned hard coat layer is formed from a composition comprising a binder resin permeable to the light-transmitting substrate and a solvent having ability to dissolve the resin particle, and a weight average molecular weight of the above-mentioned binder resin is less than 5000.

The above-mentioned solvent is preferably permeable to the light-transmitting substrate.

The present invention also provides a method for producing an optical layered body comprising: forming an antistatic layer from a composition for an antistatic layer on a light-transmitting substrate; and forming a hard coat layer with a composition for a hard coat layer on the antistatic layer; the composition for an antistatic layer comprising a conductive polymer and a resin particle, the composition for a hard coat layer comprising a binder resin and a solvent having ability to dissolve the resin particle.

The conductive polymer is preferably at least one species selected from the group consisting of polyacetylene, polyphenylene, polyphenylenevinylene, polythiophene, polyaniline, polypyrrole, polyisothianaphthene, and derivatives and conductive complexes thereof.

An average particle size of the resin particle is preferably 10 to 500 nm.

A dried thickness of the antistatic layer is preferably 10 to 500 nm.

Preferably, the composition for an antistatic layer further comprises a binder resin.

The present invention also provides an optical layered body, which is producible by the above-mentioned method for producing an optical layered body.

Preferably, the above-mentioned optical layered body substantially has no interference fringes.

Preferably, the above-mentioned optical layered body comprises at least one of an antiglare layer, a low refractive index layer, and an antifouling layer on the hard coat layer.

The above-mentioned optical layered body is preferably used as an antireflection layered body.

The present invention also provides a composition for an antistatic layer, used for forming an antistatic layer, which comprises a conductive polymer and a resin particle.

Preferably, the above-mentioned composition for an antistatic layer further comprises a binder resin.

Hereinafter, the present invention is described in detail.

The present invention provides an optical layered body, comprising: an antistatic layer on a light-transmitting substrate; and a hard coat layer on the antistatic layer, wherein the hard coat layer includes a penetration portion partially extending through the antistatic layer, and/or an impregnation portion partially extending through the antistatic layer and impregnating the light-transmitting substrate. This enables the optical layered body of the present invention to have a favorable antistatic property and also allows the hard coat layer to directly adhere to the light-transmitting substrate at the penetration portion and the impregnation portion so that the optical layered body of the present invention has a favorable self-adhesion property and recoatability.

The optical layered body of the present invention having the above-mentioned structure is producible, for example, by a method comprising: forming an antistatic layer with a composition for an antistatic layer on a light-transmitting substrate; and forming a hard coat layer with a composition for a hard coat layer on the antistatic layer; the composition for an antistatic layer comprising a conductive polymer and a resin particle, the composition for a hard coat layer comprising a binder resin and a solvent having ability to dissolve the resin particle. The method for producing an optical layered body described above is also one aspect of the present invention.

An optical layered body produced by the above-mentioned method for producing an optical layered body contains a conductive polymer, and has a favorable self-adhesion property and recoatability as well as a favorable antistatic property.

The reason for difficulty in adhesion of conductive polymers in the conventional art may be because the conductive polymers have no functional group. In the present invention, the present inventors focused on that the antistatic layer is made of a thin layer and aimed to solve the above-mentioned problems by allowing the substrate and the hard coat layer to directly adhere to each other. Namely, the above-mentioned optical layered body is configured with the substrate, antistatic layer and hard coat layer being integrated together in the given order.

In the method for producing an optical layered body of the present invention, an antistatic layer is formed from a composition for an antistatic layer containing a resin particle, and then a hard coat layer is formed from a composition for a hard coat layer. In addition, the above-mentioned composition for an antistatic layer comprises a conductive polymer and a resin particle, and the above-mentioned composition for a hard coat layer comprises a binder resin and a solvent having ability to dissolve the above-mentioned resin particle. Namely, in the process of forming a hard coat layer, part or the whole of the resin particle in the antistatic layer was dissolved in the solvent. Thereby, voids are formed in the antistatic layer, and portions of the composition for a hard coat layer impregnate into the light-transmitting substrate through the voids. Accordingly, the substrate and the hard coat layer are integrated together. As a result, the product is expected to have a favorable adhesion property.

The method for producing an optical layered body of the present invention will be described using figures. FIG. 1 illustrates an antistatic layer formed from a composition for an antistatic layer and a light-transmitting substrate. FIG. 2 illustrates a hard coat layer further formed thereon with a composition for a hard coat layer. FIG. 3 illustrates a schematic view in which resin particles in the antistatic layer dissolve or swell to form voids and the composition for a hard coat layer penetrates into the antistatic layer and further into the light-transmitting substrate. This movement is owing to ability of a solvent contained in the composition for a hard coat layer to dissolve the resin particles contained in the antistatic layer. Namely, part or the whole of the above-mentioned resin particle is dissolved by the above-mentioned solvent to form voids, and the composition for a hard coat layer invades into the voids. In order to allow the solvent to exert the ability to dissolve the resin particles, all or some of the resin particles should be in contact with the hard coat layer. The resin particles preferably project from the surface of the antistatic layer. Although not particularly limited, a part of the resin particle corresponding to 5 to 50% of the particle size of the resin particle preferably projects from the surface of the antistatic layer. Projection of the resin particles can be confirmed as follows: First, a hard coat layer is formed as described above except for using a solvent without the ability to dissolve the resin particles in the composition for a hard coat layer to obtain an optical layered body in which the resin particles in the antistatic layer are insoluble. Second, a cross-section of the optical layered body is observed by TEM.

Hereafter, a substrate and compositions used in the present invention will be specifically described in detail. In the present invention, if there is no specific description, curable resin precursors such as monomers, oligomers and prepolymers are referred to as “resins”.

### Composition for Antistatic Layer

The above-mentioned composition for an antistatic layer comprises a conductive polymer as an antistatic agent. The above-mentioned conductive polymer is not particularly limited, and may be, for example, one species selected from the group consisting of conjugated aliphatic compounds such as polyacetylene, polyacene and polyazulene, conjugated aromatic compounds such as polyphenylene, conjugated heterocyclic compounds such as polypyrrole, polythiophene and polyisothianaphthene, heteroatom-containing conjugated compounds such as polyaniline and polythienylenevinylene, fused conjugated compounds such as poly(phenylenevinylene), multi-conjugated-chain compound, that is, compounds having plural conjugated chains in a molecule, and derivatives of these conductive polymers and conductive complexes which are polymers obtainable by graft or block polymerizing these conjugated polymer chains with a saturated polymer. Especially, an organic antistatic agent such as polythiophene, polyaniline or polypyrrole is preferably used. Use of the above-mentioned organic antistatic agent enables the optical layered body to exert remarkable antistatic performance and also to have a higher total light transmittance and a lower Haze value. In order to improve the conductivity and antistatic performance, a negative ion in a form of an organic sulfonic acid, an iron chloride or the like may also be added as a dopant (electron donating agent). Considering effects obtained by addition of the dopant, polythiophene is particularly preferable owing to its high transparency and antistatic property. Polythiophene includes oligothiophene, and oligothiophene can also be suitably used. The above-mentioned derivatives are not particularly limited, and examples thereof include alkyl-group substituted polyphenylacetylene, alkyl-group substituted polydiacetylene and the like.

The above-mentioned composition for an antistatic layer comprises a resin particle (polymer bead). The above-mentioned resin particle is not particularly limited, and examples thereof include particles containing a styrenic resin, (meth)acrylic resin, vinyl acetate resin, vinyl ether resin, halogen containing resin, alicyclic olefinic resin, polycarbonate resin, polyester resin, polyamide resin, cellulose derivative, silicone resin and thermoplastic resin such as rubber or elastomer. Especially, resins with high formability or film productivity, and high transparency and weather resistance such as styrene resins, (meth)acrylyic resins, alicyclic olefinic resins, polyester resins and cellulose derivatives (cellulose esters etc.) are preferable.

According to one preferable embodiment of the present invention, when the material of the light-transmitting substrate is a cellulose resin such as triacetyl cellulose “TAC”, preferable specific examples of the thermoplastic resins include cellulose resins such as nitrocellulose, acetyl cellulose, cellulose acetate propionate and ethyl hydroxyethyl cellulose. Use of the cellulose resin can improve the adhesion property between the light-transmitting substrate and the antistatic layer and transparency of the antistatic layer.

The lower limit and the upper limit of the average particle size of the above-mentioned resin particles are preferably 10 nm and 500 nm, respectively. If the average particle size of the resin particle is less than the lower limit, it may cause reduction in durability such as heat resistance and light resistance, and also may prevent formation of a uniform coating due to higher cohesiveness caused by a large surface energy. If the average particle size of the resin particles exceeds the upper limit, an antistatic component ratio in the layer may be decreased and thereby it may be impossible to secure the antistatic property. The optical properties may also be deteriorated (a higher Haze value, a lower optical transmittance). The more preferable lower limit is 50 nm, and the more preferable upper limit is 250 nm.

The resin particle content in the above-mentioned composition for an antistatic layer can be suitably determined depending on the species of the conductive polymer to be used and the like. Normally, the resin particle is preferably contained in an amount of 1 to 50% by weight, more preferably 5 to 20% by weight in 100% by weight of the conductive polymer and the resin particle in total.

As the above-mentioned resin particle, a resin having a refractive-index with as little difference as possible from those of the conductive polymer and the binder resin to be added optionally is preferably used. Use of the resin having a refractive index with little difference enables formation of an antistatic layer with a good appearance.

The thickness (dried thickness) of the above-mentioned antistatic layer is normally about 10 to 500 nm, and particularly preferably 50 to 200 nm. An antistatic layer having a thickness of less than 10 nm is desirable in terms of optical properties such as total light transmittance and Haze, but may fail to exert desired antistatic performance (saturated electrostatic voltage of less than 2.0 kV). When an antistatic layer having a thickness exceeding 500 nm is formed, it takes a significantly long time to obtain an optical layered body having a cross-section in which the hard coat layer extends into the light-transmitting substrate through the antistatic layer, possibly resulting in inefficiency in industrial-processing. For these reasons, the layer thickness is preferably set within the above-mentioned range.

Normally, the above-mentioned composition for an antistatic layer preferably contains a solvent. The above-mentioned solvent is suitably selected from known solvents depending on the species of the conductive polymer to be used, but required to have no ability to dissolve the resin particle. When polythiophene is used as the conductive polymer, examples of the above-mentioned solvent include water, methanol, ethanol, propanol, butanol, n-amino alcohol, isoamyl alcohol, sec-amyl alcohol, tert-amyl alcohol, 1-ethyl-1-propanol, 2-methyl-1-butanol, methyl glycol, methyl glycol acetate, methyl cellosolve, ethyl cellosolve, butyl cellosolve, propylene glycol, propylene glycol nonoethyl ether, propylene glycol monobutyl ether, n-hexanol, cyclohexanol and the like. Each of these may used alone, or two or more of these may be used in combination. In order to improve the conductivity of the conductive polymer and antistatic performance, a negative ion may also be added in a form of an organic sulfonic acid, an iron chloride or the like as a dopant (electron donating agent).

The above-mentioned composition for an antistatic layer can be prepared as an aqueous composition. For example when polythiophene is used, use of polystyrene sulfonate as the dopant changes polythiophene to be hydrophilic and facilitates dissolving or dispersion of polythiophene in water. In the production method of the present invention, the above-mentioned composition for an antistatic layer can be prepared as an aqueous composition because the above-mentioned resin does not have to be dissolved therein.

A method for preparing the above-mentioned composition for an antistatic layer is not particularly limited, and the composition for an antistatic layer can be prepared according to any conventional method as long as respective components can be uniformly mixed by the method. For example, a known device such as a paint shaker, bead mill, kneader or mixer can be used.

The above-mentioned composition for an antistatic layer may further contain a binder resin. The above-mentioned binder resin is not particularly limited, and examples thereof include ionizing radiation-curable resins, solvent drying resins (resins formed into a coat only by drying a solvent having been added to adjust a solid content at application of the resin), thermosetting resins and the like. These resins are not particularly limited, and, for example, the resins listed below can be used. Especially, an ionizing radiation-curable resin that has high transparency and durability to heat and light and does not inhibit an antistatic function after being cured is preferably used.

Other materials other than the components described above may be optionally added to the above-mentioned composition for an antistatic layer. Examples of the other components include resins other than the resins described above, surfactants, coupling agents, thickeners, color protection agents, coloring agents (paints and dyes), antifoaming agents, leveling agents, fire retardants, ultraviolet ray absorbents, infrared ray absorbents, tackifiers, polymerization inhibitors, antioxidants, surface modifiers and the like. These may be known materials normally used for an antistatic layer.

The composition for an antistatic layer described above is also one aspect of the present invention.

In the present invention, the antistatic layer is specifically formed by applying the above-mentioned composition for an antistatic layer on the light-transmitting substrate to form a coat and then curing the obtained coat. A method for applying the composition is not particularly limited, and examples thereof include known methods such as a spin coating method, dip method, spray method, die coating method, bar coat method, roll coater method, meniscus coater method, flexo printing method, screen printing method and bead coater method.

A method in which the coat is formed and then optionally cured may be used. A method for curing is not particularly limited and can be suitably selected depending on the species of binder resin to be used and the like. For example, curing may be carried out by drying or irradiation with energy rays such as ultraviolet rays, if necessary.

### Hard Coat Layer

A “hard coat layer” in the present invention is defined as a layer having a hardness not less than “H” determined by the pencil hardness test according to JIS K5600-5-4 (1999). In the present invention, the hard coat layer preferably has a pencil hardness of not less than 2H and a Vickers hardness of not less than 250 N/mm.

The method for producing an optical layered body of the present invention has a process of forming a hard coat layer with a composition for a hard coat layer containing a binder resin and a solvent having ability to dissolve the above-mentioned resin particle. The above-mentioned hard coat layer is not limited as long as it has transparency. The above-mentioned binder resin is not particularly limited, and examples thereof include three types of resins: ionizing radiation-curable resins that are cured with ultraviolet rays or electron beams; mixtures of the ionizing radiation-curable resins and a solvent-drying resin (a resin formed into a coat only by drying a solvent having been added to adjust a solid content at application of the resin); and thermosetting resins. The ionizing radiation-curable resins are preferable. According to a preferable embodiment of the present invention, a resin containing at least the ionizing radiation-curable resin and the thermosetting resin can be used.

Examples of the above-mentioned ionizing radiation-curable resins include compounds having one or two or more unsaturated bonds such as compounds having an acrylate group. Examples of the compounds having one unsaturated bond include ethyl(meth)acrylate, ethylhexyl(meth)acrylate, stryrene, methylstyrene, N-vinyl pyrrolidone and the like. Examples of the compounds having two or more unsaturated bonds include reaction products (for example, poly(meth)acrylate esters of polyhydric alcohols) of a multifunctional compound such as polymethylolpropane tri(meth)acrylate, hexanediol di(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate, with (meth)acrylate or the like. “(Meth)acrylate” used herein includes methacrylate and acrylate.

In addition to the above-mentioned compounds, a resin having an unsaturated double bond with a comparatively low-molecular weight such as polyester resin, polyether resin, acrylic resin, epoxy resin, urethane resin, alkyd resin, spiroacetal resin, polybutadiene resin and polythiol-polyene resin can be used as the above-mentioned ionizing radiation-curable resin.

When using the ionizing radiation-curable resin as the ultraviolet curing resin, a photopolymerization initiator is preferably used. Specific examples of the photopolymerization initiator include acetophenones, benzophenones, Michler's benzoyl benzoate, α-amyloxime esters, thioxantones, propiophenones, benzils, benzoins, acylphosphine oxides and the like. A photosensitizing agent is also preferably mixed therein, and specific examples thereof include n-butylamine, triethylamine, poly-n-butyl phosphine and the like.

When a resin having a radically polymerizable unsaturated group is used, preferable examples of the photopolymerization initiator include acetophenones, benzophenones, thioxantones, benzoin, benzoin methyl ether and the like. Each of these may be used alone, or these are mixed to be used. When a resin having a cationically polymerizable group is used, preferable examples of the photopolymerization initiator include aromatic diazonium salts, aromatic sulfonium salts, aromatic iodonium salts, metallocene compounds, benzoin sulfonate esters and the like. Each of these may be used alone, or these are mixed to be used. The photopolymerization initiator is preferably added in an amount of 0.1 to 10 parts by weight to 100 parts by weight of the ionizing radiation-curable composition.

Principal examples of the solvent-drying resin that is mixed with the ionizing radiation-curable resin include thermoplastic resins. Examples of the thermoplastic resins include resins generally listed. Addition of the above-mentioned solvent-drying resin can effectively prevent coat defects of the coating surface. Preferable specific examples of the thermoplastic resins include the resins listed for the antistatic layer.

Examples of the thermosetting resins usable as the above-mentioned binder resin include phenol resins, urea resins, diallyl phthalate resins, melamine resins, guanamine resins, unsaturated polyester resins, polyurethane resins, epoxy resins, amino-alkyd resins, melamine-urea co-condensation resins, silicon resins, polysiloxane resins and the like. When the thermosetting resin is used, a curing agent such as crosslinking agent and polymerization initiator, a polymerization accelerator, a solvent, a viscosity modifier, and the like may be optionally used in combination.

The above-mentioned binder resin preferably has a weight average molecular weight of less than 5000. A binder resin having a weight average molecular weight of 5000 or more is not impregnated in the light-transmitting substrate, and thereby an optical layered body produced using the binder resin may fail to have a favorable self-adhesion property and recoatability. The more preferable lower limit of the weight average molecular weight is 100, and the more preferable upper limit thereof is 4000.

The weight average molecular weight can be measured by gel permeation chromatography (GPC) as a polystyrene equivalent molecular weight.

The above-mentioned composition for a hard coat layer contains a solvent having ability to dissolve the resin particle contained in the antistatic layer. The ability to dissolve used herein includes properties of swelling and wetting. A solvent of this type swells or moistens the resin particle to be dissolved therein, and portion of the composition for a hard coat layer penetrates into the antistatic layer from top to bottom and further into the light-transmitting substrate below the antistatic layer. As the above-mentioned solvent, a solvent can be selected depending on the species and solubility of the binder resin, and any solvent can be used as long as it can uniformly dissolve at least solid components (plural polymers, a curing resin precursor, a reaction initiator and other additives). Examples of a solvent of this type include ketones (acetone, methyl ethyl ketone, methyl isobutyl ketone, cyclohexanone etc.), ethers (dioxane tetrahydrofuran etc.), aliphatic hydrocarbons (hexane etc.), alicyclic hydrocarbons (cyclohexane etc.), aromatic hydrocarbons (toluene, xylene etc.), halogenated carbons (dichloromethane, dichloroethane etc.), esters (methyl acetate, ethyl acetate, butyl acetate etc.), water, alcohols (ethanol, isopropanol, butanol, cyclohexanol etc.), cellosolves (methyl cellosolve, ethylcellosolve, etc.), cellosolve acetates, sulfoxides (dimethyl sulfoxide etc.), amides (dimethylformamide, dimethylacetamide etc.), and other solvents. A mixed solvent of these may be used.

The solvent can be selected depending on whether the binder resin in the hard coat layer has the adhesion property to the substrate. For example, when the binder resin without the adhesion property to the substrate is used, a solvent having permeability to the substrate is preferably used. The property “permeability” of the permeable solvent conceptually includes properties such as permeability, swellability and wettability to the light-transmitting substrate. For example, when the substrate made of TAC is used, specific examples of the permeable solvent include ketones such as acetone, methyl ethyl ketone, cyclohexanone and diacetone alcohol; esters such as methyl formate, methyl acetate, ethyl acetate and ethyl lactate; nitrogen-containing compounds such as nitromethane, acetonitrile, N-methylpyrrolidone and N,N-dimethylformamide; glycols such as methyl glycol and methyl glycol acetate; ethers such as tetrahydrofuran, 1,4-dioxan, dioxolane and diisopropyl ether; halogenated hydrocarbons such as methylene chloride, chloroform and tetrachloroethane; glycol ethers such as methyl cellosolve, ethyl cellosolve and butyl cellosolve; cellosolve acetates; other permeable solvents such as dimethyl sulfoxide and propylene carbonate; and mixtures of these. Esters and ketones such as methyl acetate, ethyl acetate and methyl ethyl ketone are preferable. In addition, a mixture of the above-mentioned permeable solvent and an alcohol such as methanol, ethanol, isopropyl alcohol, butanol or isobutyl alcohol or an aromatic hydrocarbon such as toluene or xylene may be used.

The content (solid content) of materials in the above-mentioned composition for a hard coat layer is not limited, but normally preferably 5 to 70% by weight and particularly preferably 25 to 60% by weight.

The composition for a hard coat layer desirably contains a solvent having ability to dissolve the resin particle in the antistatic layer in an amount of 10 to 100% by weight, particularly desirably 50 to 100% by weight to the total amount of the solvents.

A resin, dispersing agent, surfactant, antistatic agent, silane coupling agent, thickener, color protection agent, coloring agent (pigment or dye), antifoaming agent, leveling agent, fire retardant, ultraviolet ray absorbent, tackiness agent, polymerization inhibitor, antioxidant or surface modifier may be added to the composition for a hard coat layer for purposes such as enhancement of hardness of the hard coat layer, suppression of cure shrinkage, controlling of the refractive index and providing an antiglare property.

A method for preparing a composition for a hard coat layer is not particularly limited as long as the respective components are uniformly mixed. For example, it may be prepared using a known device such as a paint shaker, bead mill, kneader or mixer.

The hard coat layer is specifically formed through processes of forming a coating by applying the composition for a hard coat layer and curing the obtained coating. A method for applying the composition is not particularly limited, and examples thereof include known methods such as a spin coating method, dip method, spray method, die coating method, bar coat method, roll coater method, meniscus coater method, flexo printing method, screen printing method and bead coater method.

The coat may be cured by any procedure, but is preferable cured into a hard coat layer optionally by drying, if necessary, heating and irradiating with active energy rays, and the like. A time period for drying is not particularly limited as long as it allows part or the whole of the resin particle contained in the above-mentioned composition for an antistatic layer to be dissolved. Namely, it depends on the solubility of the resin particle to the solvent. The time period for drying is, however, preferably 30 to 60 seconds, and the resin particle, solvent and the like are preferably selected so that the time period for drying is set in the above-mentioned range. The hard coat layer is preferably completely cured by procedure such as heating or irradiating with active energy rays after the resin particle is dissolved in the solvent and the composition for a hard coat layer penetrates into the antistatic layer and the light-transmitting layer as described above. The hard coat layer thus cured has a penetration portion partially extending through the antistatic layer, and an impregnation portion partially extending through the antistatic layer and impregnating the light-transmitting substrate.

Examples of the irradiation with active energy rays include irradiation with ultraviolet rays or electron beams. Examples of an ultraviolet ray source include light sources such as ultrahigh pressure mercury lamps, high-pressure mercury lamps, low-pressure mercury lamps, carbon arc lights, black light fluorescent lights and metal halide lamps. Ultraviolet rays having a wavelength in a range of 190 to 380 nm can be used. Specific examples of an electron beam source include electron beam accelerators of various types such as Cockcroft-Walton type, van de Graaff type, resonance transformer type, insulating core transformer type, linear type, dynamitron type and high frequency type.

### Light-Transmitting Substrate

The light-transmitting substrate preferably has smoothness and heat resistance as well as favorable mechanical strength. Specific examples of a material of the light-transmitting substrate include thermoplastic resins, and examples of the thermoplastic resins include acrylics such as polymethyl methacrylate, polyesters such as polyethylene terephthalate, polybutylene terephthalate, polyethylene naphthalate and polybutylene naphthalate, triacetyl cellulose, cellulose diacetate, cellulose acetate butyrate, polyesters, polyamides, polyimides, polyethersulfones, polysulfones, polypropylene, polymethylpentene, polyvinyl chloride, polyvinyl acetals, polyether ketones, polymethyl methacrylate, polycarbonates, polyurethanes and the like. Polyesters such as polyethylene terephthalate and polyethylene naphthalate, and triacetyl cellulose are preferable.

The above-mentioned thermoplastic resin is preferably used in a form of a film having a high flexibility in the above-mentioned light-transmitting substrate. A plate made of any of these thermoplastic resins or a glass plate may be used for use in which curability is required.

In addition, a film of an amorphous olefin polymer (Cyclo-Olefin-Polymer: COP) having an alicyclic structure may also be used as the light-transmitting substrate. A substrate of this type is made of a norbornene polymer, a monocyclic olefin polymer, a cyclic conjugated diene polymer, a vinyl alicyclic hydrocarbon polymer resin or the like. Examples thereof include ZEONEX and ZEONOR (norbornene resins) produced by Nippon Zeon Co., Ltd., SUMILITE FS-1700 produced by Sumitomo Bakelite Co., Ltd., ARTON (modified norbornene resin) produced by JSR Corporation, APEI (cyclic olefin copolymer) produced by Mitsui Chemicals, Inc., Topas (cyclic olefin copolymer) produced by Ticona Inc., and OPTOREZ OZ-1000 series (alicyclic acrylic resins) produced by Hitachi Chemical Co., Ltd.

Further, FV series (low birefringence and low photoelastic coefficient film) produced by Asahi Kasei Chemicals Corporation are also preferable as an alternative substrate of triacetyl cellulose.

The thickness of the light-transmitting substrate is preferably 20 μm or more, and 300 μm or less. The upper limit is more preferably 200 μm and the lower limit is more preferably 30 μm. When the light-transmitting substrate is a plate-like body, the light-transmitting substrate may have a thickness thicker or thinner than the range, that is, a thickness of 300 μm or more or 5000 μm or less. In order to enhance the adhesion property, the substrate may be subjected to physical treatments such as corona discharge treatment and oxidation treatment, or may be coated by a coating composition such as an anchoring agent or primer before forming layers such as the hard coat layer and the antistatic layer on the substrate.

An optical layered body obtained by the method for producing an optical layered body of the present invention is also one aspect of the present invention.

In the present invention, any structure is applicable as long as it contains a basic layer structure in which the antistatic layer is formed on the light-transmitting substrate and the hard coat layer is formed on the antistatic layer.

One or two or more of other layers such as an antiglare layer, low refractive index layer, antifouling layer, adhesive layer and another hard coat layer may be optionally formed on the hard coat layer as long as the optical layered body of the present invention does not lose properties such as optical transparency. Especially, at least one of the antiglare layer, low refractive index layer, and antifouling layer is preferably formed on the hard coat layer. These layers may be the same as those formed in known antireflection layered bodies.

### Antiglare Layer

An antiglare layer may be formed, for example, between the light-transmitting substrate and the hard coat layer, or between the light-transmitting substrate and a low refractive index layer (described below). The above-mentioned antiglare layer may be formed from a composition for an antiglare layer containing a resin, a solvent and an antiglare agent.

The resin can be suitably selected from those described in the section on the composition for a hard coat layer. Although the solvent can also be suitably selected from those described in the section on the composition for a hard coat layer, a solvent having ability to dissolve or swell the light-transmitting substrate is preferably selected. When the light-transmitting substrate is made of triacetyl cellulose, methyl ethyl ketones, methyl acetate are preferable as the solvent.

Fine particles of any type can be used as the above-mentioned antiglare agent. The average particle size of the fine particles is not limited, but normally about 0.01 to 20 μm. The fine particles may have any shape such as sphere, ellipse and nonspherical forms but are preferably spherical.

Examples of the above-mentioned fine particles include inorganic fine particles and organic fine particles.

The above-mentioned fine particles have the antiglare property, and preferably have transparency. Preferable specific examples of the inorganic fine particles include silica beads (although not limited, silica beads having a surface hydrophobilized by treating with an organic substance are preferable.) Examples of the organic fine particles include plastic beads. Specific examples of the plastic beads include styrene beads (refractive index: 1.60), melamine beads (refractive index: 1.57), acrylic beads (refractive index: 1.49 to 1.53), acryl-styrenebeads (refractive index: 1.54 to 1.58), polycarbonate beads, polyethylene beads, benzoguanamine beads, benzoguanamine-formaldehyde condensation beads and the like.

Normally, the antiglare layer (after cured) preferably has a dried thickness in a range of about 0.1 to 100 μm, particularly preferably in a range of 0.0 to 10 μm. The antiglare layer having a thickness in this range can function with sufficient performance.

### Low Refractive Index Layer

A low refractive index layer functions to reduce the reflective index of light (for example, fluorescent light, natural light, etc.) from outside reflecting on the surface of the optical layered body. The low refractive index layer preferably has a refractive index of 1.45 or less, particularly preferably 1.42 or less.

The dried thickness of the low refractive index layer is not limited, but normally suitably set within a range of about 30 nm to 1 μm.

The low refractive index layer may be composed of any of 1) a resin containing silica or magnesium fluoride, 2) a fluorine material being a low refractive index resin, 3) a fluorine material containing silica or magnesium fluoride, and 4) a thin film of silica or magnesium fluoride.

The resins other than the fluoride materials may be the same materials as the resins for the above-mentioned composition for a hard coat layer.

The above-mentioned fluorine materials may be polymerizable compounds containing at least a fluorine atom in the molecule or polymers thereof. The above-mentioned polymerizable compounds are not particularly limited, and preferable examples thereof include compounds having a curing reactive group such as an ionizing radiation-curable group and a heat-curable polar group. Alternatively, compounds having these reactive groups in combination may also be used. Unlike the polymerizable compounds, the above-mentioned polymers have no reactive groups listed above.

As the polymerizable compound having an ionizing radiation-curable group, fluoride-containing monomers having an ethylenic unsaturated bond can be widely used. Specific examples thereof include fluoroolefins (for example, fluoroethylene, vinylidene fluoride, tetrafluoroethylene, hexafluoropropylene, perfluorobutadiene, perfluoro-2,2-dimethyl-1,3-dioxole etc.). Other examples include compounds having a (meth)acryloyloxy group such as fluorine-containing (meth)acrylate compounds (2,2,2-trifluoroethyl(meth)acrylate, 2,2,3,3,3-pentafluoropropyl(meth)acrylate, 2-(perfluorobutyl)ethyl(meth)acrylate, 2-(perfluorohexyl)ethyl(meth)acrylate, 2-(perfluorooctyl)ethyl(meth)acrylate, 2-(perfluorodecyl)ethyl(meth)acrylate, α-trifluoromethyl methacrylate, α-trifluoroethyl methacrylate etc.); fluorine-containing polyfunctional (meth)acrylic ester compounds having a C1-14 fluoroalkyl group, a C1-14 fluorocycloalkyl group or a C1-14 fluoroalkylene group with at least three fluorine atoms and at least two (meth)acryloyloxy groups, and the like.

Preferable examples of the heat-curable polar group include groups for forming a hydrogen bond, such as hydroxyl group, carboxyl group, amino group and epoxy group. These have favorable affinity to inorganic ultrafine particles such as silica as well as a favorable adhesion property to a coat.

Examples of the polymerizable compounds having a thermosetting polar group include 4-fluoroethylene-perfluoroalkyl vinyl ether copolymers; fluoroethylene-hydrocarbon vinyl ether copolymers; fluoride-modified products of various resins such as epoxy, polyurethane, cellulose, phenol and polyimide.

Examples of the polymerizable compounds having an ionizing radiation-curable group and a heat-curable polar group in combination include partially or fully fluorinated alkyl, alkenyl, or aryl esters of acrylic acid or methacrylic acid, fully or partially fluorinated vinyl ethers of acrylic acid or methacrylic acid, fully or partially fluorinated vinyl esters of acrylic acid or methacrylic acid, fully or partially fluorinated vinyl ketones of acrylic acid or methacrylic acid, and the like.

Examples of the fluororesin include polymers of a monomer or a monomer mixture containing at least one of fluorine-containing (meth)acrylate compounds of the polymerizable compounds having an ionizing radiation-curable group; copolymers of at least one of the above-mentioned fluorine-containing (meth)acrylate compound and a (meth)acrylate compound without a fluorine atom in the molecule such as methyl(meth)acrylate, ethyl(meth)acrylate, propyl (meth)acrylate, butyl(meth)acrylate and 2-ethylhexyl (meth)acrylate; and monopolymers or copolymers of a fluorine-containing monomer such as fluoroethylene, vinylidene fluoride, trifluoroethylene, chlorotrifluoroethylene, 3,3,3-trifluoropropylene, 1,1,2-trichloro-3,3,3-trifluoropropylene and hexafluoropropylene. As the fluororesin, silicone-containing vinylidene fluoride copolymers, which contains and the above-mentioned polymers and a silicone component, can also be used.

The silicone component is not particularly limited, and examples thereof include (poly)dimethylsiloxane, (poly)diethylsiloxane, (poly)diphenylsiloxane, (poly)methylphenylsiloxane, alkyl modified (poly)dimethylsiloxane, azo group-containing (poly)dimethylsiloxane, dimethylsilicone, phenylmethylsilicone, alkyl-aralkyl modified silicone, fluorosilicone, polyether modified silicone, aliphatic acid ester modified silicone, methyl hydrogen silicone, silanol group-containing silicone, alkoxy group-containing silicone, phenol group-containing silicone, methacryl modified silicone, amino modified silicone, carboxylic acid modified silicone, carbinol modified silicone, epoxy modified silicone, mercapto modified silicone, fluorine modified silicone, polyether modified silicone and the like. Among these, silicone components having a dimethylsiloxane structure are preferable.

Since polydimethylsiloxane polymers are preferably used since the contact angle can be widened in terms of the characteristics. Specific examples of such siloxanes include mixtures obtained by adding various kinds of crosslinking agents, e.g. tetrafunctional silanes such as tetraacetoxysilane, tetraalkoxysilane, tetraethylmethylketoximesilane, tetraisopropenylsilane, and the like; and also trifunctional silanes such as alkyl or alkenyltriacetoxysilane, triketoximesilane, triisopropenylsilane, trialkoxysilane, and the like to polyalkyl-, polyalkenyl-, and polyarylsiloxane such as polydimethylsiloxane, polymethylphenylsiloxane and polymethylvinylsiloxane having silanol group at terminals, and in some cases, previously reacted mixtures.

Non-polymers or polymers of the following compounds can also be used as the fluororesin. Namely, a compound obtained by reacting a fluorine-containing compound having at least one isocyanato group in the molecule and a compound having at least one functional group reactive with the isocyanato group such as amino group, hydroxyl group or carboxyl group in the molecule; a compound obtained by reacting a fluoride-containing polyol such as a fluoride-containing polyether polyol, fluoride-containing alkyl polyol, fluoride-containing polyester polyol and fluoride-containing ∈-caprolactone modified polyol, and the like with a compound having an isocyanato group, can be used.

The resin components listed for the composition for a hard coat layer can also be mixed with the above-mentioned fluorine-containing polymerizable compound or polymer.

Additionally, a curing agent for curing a reactive group or the like, or an additive or a solvent of any type for improving coatability or providing an antifouling property can be suitably used.

In forming the low refractive index layer, the low refractive index layer can be formed from a composition (a refractive index layer-forming composition) containing, for example, a raw material component. More specifically, a solution or a dispersion formed by dissolving and dispersing the raw material component (resin, etc.) and the additives (for example, “fine particles having voids” described later, a polymerization initiator, an antistatic agent, an antiglare agent, etc.) as required in a solvent is used as a low refractive index layer-forming composition, and a coat of the composition is formed, and the coat is cured, and thereby a low refractive index layer can be obtained. In addition, examples of the additives such as the polymerization initiator, the antistatic agent, and the antiglare agent include the additives publicly known.

“The fine particles having voids” are preferably used as a low-refractive-index agent for the low refractive index layer. “The fine particles having voids” can reduce the refractive index of the low refractive index layer as well as maintain layer strength of the low refractive index layer. In the present invention, “the fine particles having voids” include fine particles each having a structure with a gas filling the inside thereof and/or a porous structure with a gas and also having a refractive index lower than its original refractive index in inverse proportion to a proportion of the gas in the fine particle. In the present invention, “the fine particles having voids” also include fine particles which can form a nanoporous structure in the inside of a coat and/or in at least a part of the coat surface depending on the form, structure or agglomeration condition of the fine particles or dispersion condition of the fine particles in the coat. A low refractive index layer formed using these fine particles can be adjusted to have a refractive index of 1.30 to 1.45.

Examples of inorganic fine particles having voids include a silica fine particle prepared by a method disclosed in JP-A 2001-233611. Silica particles obtainable by production methods disclosed in JP-A 07-133105, JP-A 2002-79616, and JP-A 2006-106714 etc. may also be used. Since silica fine particles having voids are easily produced and have high hardness as they are, a low refractive index layer formed using the particles mixed with a binder has enhanced layer strength and can be adjusted to have a refractive index within a range of about 1.20 to 1.45. In particular, preferable specific examples of organic fine particles having voids include hollow polymer particles prepared by the technique disclosed in JP-A 2002-80503.

Examples of the particles which can form a nanoporous structure in the inside of a coat and/or in at least a part of the coat surface include a slow-release agent that is produced for the purpose of increasing a specific surface area and allows adsorption of various chemical substances on a column for filling and a porous portion of the column surface, porous particles used for fixing a catalyst, and dispersed substances or agglomerated substances of hollow particles which are incorporated in a heat insulating material or a low dielectric material for use, in addition to the above-mentioned silica particles. Specific examples thereof include particles having a particle size within the preferable range of the present invention out of agglomerated substances of porous silica particles of commercially available Nipsil or Nipgel (trade names) produced by Nihon silica kogyo corporation and colloidal silica UP series (trade name) having a structure in which silica particles are linked with one another in a chain form produced by Nissan Chemical Industries, Ltd.

An average particle size of the “fine particles having voids” is 5 nm or more and 300 nm or less, and preferably, the lower limit is 8 nm or more and the upper limit is 100 nm or less, more preferably, the lower limit is 10 nm or more and the upper limit is 80 nm or less. The particles having an average particle size in this range can give remarkable transparency to the low refractive index layer. The average particle size is measured by a dynamic light-scattering method. The “fine particles having voids” is normally contained in the low refractive index layer in an amount of about 0.1 to 500 parts by weight with respect to 100 parts by weight of a matrix resin, and preferably in an amount of about 10 to 200 parts by weight.

The above-mentioned solvent is not particularly limited, and examples thereof include solvents listed above for the composition for a hard coat layer. Methyl isobutyl ketone, cyclohexanone, isopropyl alcohol (IPA), n-butanol, t-butanol, diethyl ketone, PGME and the like are preferably.

The composition for a low refractive index layer can be prepared by any method, and a conventional method can be used as long as components can be uniformly mixed by the method. For example, any of the known devices listed above for forming the hard coat layer can be used for mixing.

A coating may be formed according to a known method. For example, the various methods listed above for forming a hard coat layer can be used.

Upon forming the low refractive index layer, it is preferable to set the viscosity of the composition for a low refractive index layer in a range of 0.5 to 5 cps (25° C.) where a desirable application property is attained, and more preferably 0.7 to 3 cps (25° C.). By setting the viscosity in this range, an excellent antireflection film of visible light can be realized, a uniform thin film can be formed without producing irregularity of application, and a low refractive index layer having particularly excellent adhesion to the substrate can be formed.

A method for curing the obtained coat may be suitably selected depending on the components in the composition and the like. For example, an ultraviolet curable component can be cured by irradiating the coat with ultraviolet rays. When a heating means is used for the curing treatment, for example, a heat-polymerization initiator which is heated to generate radicals and initiates the polymerization of a polymerizable compound is preferably added.

A thickness (nm) d_{A} of the low refractive index layer preferably satisfies the following equation (V):

d_{A}=mλ/(4n_{A}) (V)

wherein n_{A} represents a refractive index of the low refractive index layer, m represents a positive odd (preferably 1), λ represents a wavelength (preferably a value of 480 to 580 nm).

Further, in the present invention, from the viewpoint of reducing a reflection factor, the low refractive index layer preferably satisfies the following equation (VI):

120<n_{A}d_{A}<145 (VI).

### Antifouling Layer

An antifouling layer is a layer for preventing deposition of stains (fingerprints, water-based or oil-based inks, pencils, and the like) on the outermost layer of the optical layered body or making it easy to wipe out the stains even in the case of deposition. According to a preferable embodiment of the present invention, an antifouling layer may be formed for the purpose of protecting the outermost surface of the low refractive index layer from stains. In particular, the antifouling layer is preferably formed on both of the faces of the optical layered body, that is, the face on a side in which the low refractive index layer is formed and the other face on the light-transmitting substrate side. Formation of the antifouling layer enables further improvement of the antifouling property and a scratching resistance of the optical layered body. Without the low refractive index layer, the antifouling layer may be formed for the purpose of protecting the outermost surface from stains.

The antifouling layer can be normally formed from a composition containing an antifouling agent and resin. The above-mentioned antifouling agent is used mainly for the purpose of protecting the outermost surface of the optical layered body from stains and may also give the scratching resistance to the optical layered body. Examples of the above-mentioned antifouling agent include fluorine compounds, silicon compounds, and mixed compounds of these. More specific examples of the antifouling agent include silane coupling agents having a fluoroalkyl group such as 2-perfluorooctylethyltriaminosilane. Especially, compounds having an amino group can be preferably used among these. The above-mentioned resin is not particularly limited, and examples thereof include the resins listed for the above-mentioned composition for a hard coat layer.

The antifouling layer can be formed, for example, on the hard coat layer. In particular, the antifouling layer is desirably formed to be the outermost surface. For example, the hard coat layer itself may be provided the antifouling property instead of forming the antifouling layer.

The optical layered body of the present invention preferably has at least one of the antiglare layer, the low refractive index layer, and the antifouling layer on the hard coat layer. FIG. 4 illustrates an optical layered body having all these layers. The optical layered body of the present invention preferably has the antiglare layer among these.

### Interface and Other Characteristics of Optical Layered Body

The optical layered body of the present invention desirably has substantially no interface. Herein, the meaning of the phrase “(substantially) no interface” may include 1) faces of two layers overlap but actually without an interface, and 2) there is no interface between faces of two layers in terms of the refractive index.

Specifically, whether the optical layered body has “(substantially) no interface” is determined by observation of interference fringes of the optical layered body. That is, a black tape is stuck to the back side of the optical layered body, and the optical layered body is visually observed from above under illumination by a three-wavelength fluorescent lamp. Here, if interference fringes are observed, an interface is found by another observation of a cross-section of the optical layered body using a laser microscope. This result is therefore determined as “having an interface”. On the other hand, if interference fringes are not observed or extremely slightly observed, an interface is not found or extremely thinly found by another observation of a cross-section of the optical layered body using a laser microscope. This result is therefore determined as “having substantially no interface”. That is, the optical layered body of the present invention desirably has substantially no interference fringe. Here, the laser microscope can read out light reflected from respective interfaces and enables nondestructive observation of a cross-section. That is because an interface is observed as a refractive index difference between two layers only in the case where there are refractive index differences between them.

Therefore, when no interface is observed, there is regarded to be no difference in the refractive index and thereby no interface.

As described above, the hard coat layer is continuously found extending into the light-transmitting substrate through the antistatic layer by appearance observation of the cross-section of the optical layered body of the present invention. This structure effectively enables the hard coat layer, the antistatic layer and the light-transmitting substrate to be substantially integrated all together. As a result, the optical layered body of the present invention can exert a high adhesion property.

The optical layered body of the present invention is also suitably used as an antireflection layered body.

### EFFECTS OF THE INVENTION

The optical layered body of the present invention is configured as described above, and thereby has a favorable antistatic property and can exert a favorable self-adhesion property and recoatability. Therefore, the optical layered body of the present invention can be suitably applied to cathode ray tube (CRT) display devices, liquid crystal displays (LCD), plasma displays (PDP), electroluminescence displays (ELD) and the like.

### BRIEF DESCRIPTION OF THE DRAWINGS

FIG. 1 is a schematic view of a light-transmitting substrate and an antistatic layer.

FIG. 2 is a schematic view of the light-transmitting substrate, the antistatic layer and a hard coat layer.

FIG. 3 is a schematic view of the light-transmitting substrate, the antistatic layer and the hard coat layer.

FIG. 4 is a schematic view of the light-transmitting substrate, the antistatic layer, the hard coat layer, an antiglare layer, a low refractive index layer and an antifouling layer.

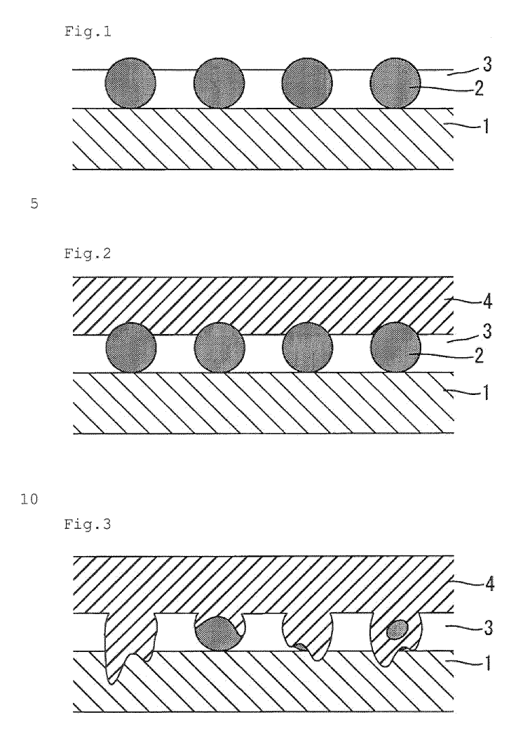

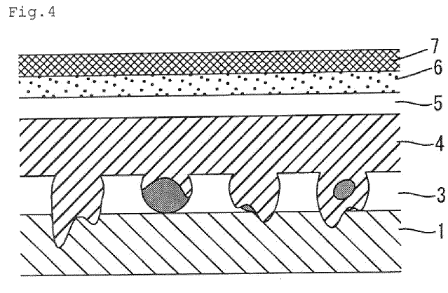

### EXPLANATION OF SYMBOLS

1 Light-transmitting substrate
2 Resin particle
3 Composition for an antistatic layer
4 Composition for a hard coat layer
5 Antiglare layer
6 Low refractive index layer
7 Antifouling layer

### BEST MODE FOR CARRYING OUT THE INVENTION

Hereinafter, the present invention will be described in more detail by way of examples, but the present invention is not limited to these examples.

### Example 1

### Preparation of Composition for Antistatic Layer

A composition for an antistatic layer was prepared by mixing the following components.

| | |
|---|---|
| Polyaniline ink (product name: | Solid content 12.0 parts by weight |
| ORMECON, produced by | |
| Nissan Chemical Industries, Ltd.) | |
| Polyester particle dispersion liquid | Solid content 0.5 parts by weight |

### Preparation of Composition for Hard Coat Layer

A composition for a hard coat layer was prepared by mixing the following components.

| | |
|---|---|
| Pentaerythritol triacrylate (PETA) | 30.0 parts by weight |
| IRGACURE 907 (product name, | 1.5 parts by weight |
| produced by Ciba Specialty | |
| Chemicals Inc.) | |
| Methyl isobutyl ketone | 73.5 parts by weight |

### Production of Optical Layered Body

The prepared composition for an antistatic layer was bar coated with a Mayer bar (metering coating rod) on a 100 μm treated surface of a PET film treated for easy adhesion (A4300; light-transmitting substrate) produced by Toyobo Co., Ltd., and then dried in a ventilation oven at 70° C. for 30 seconds to remove the solvent. Thus, a polyester particle-containing resin layer (antistatic layer) having a dried thickness of 300 nm was obtained. The average particle size of the polyester particles in the antistatic layer was found to be about 350 nm by microscopic observation.

Subsequently, a composition for a hard coat layer was bar coated to form a hard coat layer. At this time, the polyester particles in the lower layer were dissolved in the solvent in the composition so that the composition for a hard coat layer penetrated through the antistatic layer. In addition, the PET film (portions treated for easy adhesion of the film) was dissolved in the solvent in the composition so that the composition for a hard coat layer further permeated. The solvent was removed by drying, and then the hard coat layer was subjected to irradiation with ultraviolet rays at an irradiation dose of 100 mJ/cm² using an ultraviolet irradiation apparatus (fusion UV system Japan, Inc., light source: H valve) to be cured. The hard coat layer thus obtained had a coating thickness of 5 μm.

### Example 2

An optical layered body was produced by following the same procedure as in Example 1 except that instead of using the polyaniline ink, the same amount of a polythiophene ink (PEDOT:PSS, produced by Sigma Aldrich Corporation) was used as the conductive polymer ink.

### Example 3

An optical layered body was produced by following the same procedure as in Example 1 except that instead of using the polyaniline ink, the same amount of an oligothiophene ink (DH-6T, produced by Sigma Aldrich Corporation) was used as the conductive polymer ink.

### Comparative Example 1

An optical layered body was produced by following the same procedure as in Example 1 except that a composition containing polyaniline ink but without the polyester particle dispersion liquid was used as the composition for an antistatic layer.

### Comparative Example 2

An optical layered body was produced by following the same procedure as in Example 2 except that a composition containing polythiophene ink but without the polyester particle dispersion liquid was used as the composition for an antistatic layer.

### Comparative Example 3

An optical layered body was produced by following the same procedure as in Example 3 except that a composition containing oligothiophene ink but without the polyester particle dispersion liquid was used as the composition for an antistatic layer.

### Example 4

### Preparation of Composition for Antistatic Layer

A composition for an antistatic layer was prepared by mixing the following components.

| | |
|---|---|
| Polyaniline ink (product name: | Solid content 12.0 parts by weight |
| ORMECON, produced by | |
| Nissan Chemical Industries, Ltd.) | |
| Polyester particle dispersion liquid | Solid content 0.5 parts by weight |

### Preparation of Composition for Hard Coat Layer

A composition for a hard coat layer was prepared by mixing materials having the following compositions.

| | |
|---|---|
| Pentaerythritol triacrylate (PETA) | 30.0 parts by weight |
| IRGACURE 184 (product name, produced by Ciba | 1.5 parts by weight |
| Specialty Chemicals Inc.) | |
| Methyl ethyl ketone | 73.5 parts by weight |

### Production of Optical Layered Body

The prepared composition for an antistatic layer was bar coated with Meyer bar (metering coating rod) on a triacetyl cellulose substrate (produced by FUJIFILM Corporation, thickness: 80 μm) used as the light-transmitting substrate, and then dried in a ventilation oven at 70° C. for 30 seconds to remove the solvent. Thus, a polyester particle-containing resin layer (antistatic layer) having a dried thickness of 300 nm was obtained. The average particle size of the polyester particles in the antistatic layer was found to be about 350 nm by microscopic observation.

Subsequently, a composition for a hard coat layer was bar coated to form a hard coat layer. At this time, the polyester particles in the lower layer was dissolved so that the composition for a hard coat layer penetrated through the antistatic layer and permeated into the triacetyl cellulose substrate. The solvent was removed by drying, and then the hard coat layer was subjected to irradiation with ultraviolet rays at an irradiation dose of 100 mJ/cm² using an ultraviolet irradiation apparatus (fusion UV system Japan, Inc., light source: H valve) to be cured. The hard coat layer thus obtained had a coating thickness of 5 μm.

### Example 5

An optical layered body was produced by following the same procedure as in Example 4 except that instead of using the polyaniline ink, the same amount of a polythiophene ink (PEDOT:PSS, produced by Sigma Aldrich Corporation) was used as the conductive polymer ink.

### Example 6

An optical layered body was produced by following the same procedure as in Example 4 except that instead of using the polyaniline ink, the same amount of an oligothiophene ink (DH-6T, produced by Sigma Aldrich Corporation) was used as the conductive polymer ink.

### Comparative Example 4

An optical layered body was produced by following the same procedure as in Example 4 except that a composition containing polyaniline ink but without the polyester particle dispersion liquid was used as the composition for an antistatic layer.

### Comparative Example 5

An optical layered body was produced by following the same procedure as in Example 5 except that a composition containing polythiophene ink but without the polyester particle dispersion liquid was used as the composition for an antistatic layer.

### Comparative Example 6

An optical layered body was produced by following the same procedure as in Example 6 except that a composition containing oligothiophene ink but without the polyester particle dispersion liquid was used as the composition for an antistatic layer.

Surface resistivity, the adhesion property and preventing interference fringe property of the optical layered bodies obtained in Examples 1 to 6 and Comparative Examples 1 to 6 were evaluated by the following evaluation methods. Table 1 shows the measurement results.

### <Surface Resistivity>

The surface resistivity (0/square) was measured by applying a voltage of 1000 V with a surface resistivity measuring instrument (produced by Mitsubishi Chemical Corporation, product number: Hiresta IP MCP-HT260).

### <Adhesion Property>

### Application Adhesion Property (JIS K 5600):

In total, one hundred 1-mm square grids were formed. The sample was subjected to a peel test continuously 5 times using industrial 24-mm Sellotape (registered trademark) produced by NICHIBAN Co., Ltd., and the number of remained grids was shown;

### <Preventing Interference Fringe Property Test>

In order to prevent back reflection, a black tape was applied to a face on a side opposite to a face on a side in which the antistatic layer and the hard coat layer are formed in each of the optical layered bodies of Examples and Comparative Examples, and each optical layered body was visually observed under three-wavelength fluorescence from the hard coat layer side and evaluated according to the following evaluation criteria.

### Evaluation Criteria

Evaluation “Good”: No interference fringes were found by all-direction visual observation.

Evaluation “Bad”: Interference fringes were found by the all-direction visual observation.

Expression of the conductivity (antistatic property) derived from polyaniline or polythiophene was confirmed in both Examples and Comparative Examples. However, the adhesion properties were clearly different between them. Namely, the adhesion property was not secured at all in each of Comparative Examples; however, the adhesion property as high as those of commercial products was achieved in each of Examples. Therefore, the method of the present invention was confirmed effective to obtain both of antistatic performance and high adhesion performance.

The preventing interference fringe property was also confirmed in each of Examples. On the contrary, interference fringes could not be avoided in Comparative Examples unlike Examples. This is because the hard coat layer did not impregnate the light-transmitting substrate through the antistatic layer. The method of the present invention was found capable of avoiding interference fringes and substantially did not form interfaces between the substrate and the laminating layer.

TABLE 1

| | Surface | | Preventing |
|---|---|---|---|
| | resistivity | Adhesion | Interference fringes |
| Samples | (Ω/sq.) | property | property |
| Example 1 | 5.8 × 10¹¹ | 100/100 | Good |
| Example 2 | 2.0 × 10¹¹ | 100/100 | Good |
| Example 3 | 6.6 × 10¹² | 100/100 | Good |
| Example 4 | 4.6 × 10¹¹ | 100/100 | Good |
| Example 5 | 2.8 × 10¹¹ | 100/100 | Good |
| Example 6 | 5.9 × 10¹² | 100/100 | Good |
| Comparative Example 1 | 3.6 × 10¹¹ | 0/100 | Bad |
| Comparative Example 2 | 8.7 × 10¹⁰ | 0/100 | Bad |
| Comparative Example 3 | 3.0 × 10¹³ | 0/100 | Bad |
| Comparative Example 4 | 3.4 × 10¹¹ | 0/100 | Bad |
| Comparative Example 5 | 9.0 × 10¹⁰ | 0/100 | Bad |
| Comparative Example 6 | 2.7 × 10¹³ | 0/100 | Bad |

### INDUSTRIAL APPLICABILITY

The present invention enables production of an optical layered body having favorable antistatic performance, self-adhesion property, and recoatability in a simple manner.

The obtained optical layered body can be suitably used preferably as an antirefrection layered body. Therefore, the optical layered body of the present invention can be suitably applied to cathode ray tube (CRT) display devices, liquid crystal displays (LCD), plasma displays (PDP), electroluminescence displays (ELD), and the like.

1. An optical layered body, comprising:
an antistatic layer on a light-transmitting substrate; and a hard coat layer on the antistatic layer,
wherein the hard coat layer includes a penetration portion partially extending through the antistatic layer, and/or an impregnation portion partially extending through the antistatic layer and impregnating the light-transmitting substrate.

2. The optical layered body according to claim 1,
wherein the light-transmitting substrate is made of triacetylcellulose.

3. The optical layered body according to, claim 1,
wherein the antistatic layer is formed from a composition for an antistatic layer comprising a resin particle, and
the resin particle has a particle size so that a part of the resin particle corresponding to 5 to 50% of the particle size of the resin particle projects from the surface of the antistatic layer.

4. The optical layered body according to claim 1,
wherein the hard coat layer is formed from a composition comprising a binder resin permeable to the light-transmitting substrate and a solvent having ability to dissolve the resin particle, and
a weight average molecular weight of the binder resin is less than 5000.

5. The optical layered body according to claim 4,
wherein the solvent is permeable to the light-transmitting substrate.

6. A method for producing an optical layered body comprising:
forming an antistatic layer with a composition for an antistatic layer on a light-transmitting substrate; and
forming a hard coat layer with a composition for a hard coat layer on the antistatic layer;
the composition for an antistatic layer comprising a conductive polymer and a resin particle,
the composition for a hard coat layer comprising a binder resin and a solvent having ability to dissolve the resin particle.

7. The method for producing an optical layered body according to claim 6,
wherein the conductive polymer is at least one species selected from the group consisting of polyacetylene, polyphenylene, polyphenylenevinylene, polythiophene, polyaniline, polypyrrole, polyisothianaphthene, and derivatives and conductive complexes thereof.

8. The method for producing an optical layered body according to claim 6,
wherein an average particle size of the resin particle is 10 to 500 nm.

9. The method for producing an optical layered body according to claim 6,
wherein a dried thickness of the antistatic layer is 10 to 500 nm.

10. The method for producing an optical layered body according to claim 6,
wherein the composition for an antistatic layer further comprises a binder resin.

11. An optical layered body,
which is producible by the method for producing an optical layered body according to claim 6.

12. The optical layered body according to claim 11,
which has substantially no interference fringes.

13. The optical layered body according to claim 11, comprising:
at least one of an antiglare layer, a low refractive index layer, and an antifouling layer on the hard coat layer.

14. The optical layered body according to claim 11,
which is used as an antireflection layered body.

15. A composition for an antistatic layer, used for forming an antistatic layer,
which comprises a conductive polymer and a resin particle.

16. The composition for an antistatic layer according to claim 15, further comprising a binder resin.

17. The optical layered body according to claim 2,
wherein the antistatic layer is formed from a composition for an antistatic layer comprising a resin particle, and
the resin particle has a particle size so that a part of the resin particle corresponding to 5 to 50% of the particle size of the resin particle projects from the surface of the antistatic layer.

18. The optical layered body according to claim 2,
wherein the hard coat layer is formed from a composition comprising a binder resin permeable to the light-transmitting substrate and a solvent having ability to dissolve the resin particle, and
a weight average molecular weight of the binder resin is less than 5000.

19. The optical layered body according to claim 3,
wherein the hard coat layer is formed from a composition comprising a binder resin permeable to the light-transmitting substrate and a solvent having ability to dissolve the resin particle, and
a weight average molecular weight of the binder resin is less than 5000.

20. The method for producing an optical layered body according to claim 7,
wherein an average particle size of the resin particle is 10 to 500 nm.
